(19) United States
(12) Patent Application Publication
(10) Pub. No.: US 2026/0142914 A1
(43) Pub. Date: May 21, 2026

(54) AUTONOMOUS COMPUTER NETWORK ROUTE CONFIGURATION BASED ON SCALABLE LINK SPEED METRICS

(71) Applicant: Cisco Technology, Inc., San Jose, CA (US)

(72) Inventors: Kyle Andrew Donald Mestery, Woodbury, MN (US); Jesse Daniel Backman, San Francisco, CA (US)

(21) Appl. No.: 19/200,480

(22) Filed: May 6, 2025

Related U.S. Application Data
(60) Provisional application No. 63/722,586, filed on Nov. 19, 2024.

(51) Int. Cl. H04L 45/302; H04L 45/00; H04L 45/12

(52) U.S. Cl. CPC H04L 45/304; H04L 45/12; H04L 45/54

(57) ABSTRACT

A network device includes a processor and a non-transitory computer-readable storage medium storing logic executable by the processor to perform operations. The operations include receiving, from a second network device, an advertisement for a subnet and a first value of an inbound path preference attribute of a routing protocol; determining a link speed of a link between the network device and a third network device; determining a second value of the inbound path preference attribute based on the received first value and the determined link speed; advertising the subnet to the third network device in association with the second value of the inbound path preference attribute; and routing a data packet from the third network device to the second network device in accordance with a routing table comprising a routing entry based on the first value of the inbound path preference attribute

### CROSS-REFERENCE TO RELATED APPLICATIONS

This application claims the benefit of U.S. Provisional Application No. 63/722,586, filed Nov. 19, 2024, which is incorporated by reference herein.

### TECHNICAL FIELD

The present disclosure relates generally to computer networks. More particularly, the present disclosure relates to configuring one or more network devices using a routing protocol.

### BACKGROUND

Computer networks connect computing devices using a variety of techniques involving hardware, software, and protocols. Myriad devices, programs, and protocols exist to enable networking functionality among computing devices, including network switches, Free Range Routing (FRR), and Border Gateway Protocol (BGP). Different computing environments, such as the local area network (LAN) of an organization, employ a combination of hardware, software, and protocols to connect computing devices of the organization to one another and computing devices outside the LAN, such as computing devices accessible over the internet. Some organizations have multiple large computing environments, which may be networked using network fabrics to facilitate efficient data transport.

Configuring a computer network, such as a network fabric, can be complex and time-consuming, and can require significant amounts of labor by specialists to properly set up hardware and implement appropriate software and protocols. Nonetheless, mistakes can be made during the configuration of a network that can reduce the operating efficiency of the network. For example, the network fabric of a data center can be improperly configured, causing problems such as high latency, bottlenecking, packet loss, single points of failure, and so on. Network configuration problems can be especially pernicious when the problems exist at the hardware level, such as an underlay network that includes less-than-optimally cabled network devices, including improper connections between network devices or the use of incorrect cables, e.g., cables of lower bandwidth than intended by a network engineer.

### SUMMARY OF THE DISCLOSURE

Systems and methods for configuring one or more network devices using a routing protocol in accordance with embodiments of the disclosure are described herein. In various embodiments, a network device may include a processor and a non-transitory computer-readable storage medium. The storage may be coupled to the processor and may include a network configuration logic configured to perform operations when executed by the processor. The network configuration logic may be configured to receive, from a second network device, an advertisement for a subnet and a first value of an inbound path preference attribute of a routing protocol; determine a link speed of a link between the network device and a third network device; determine a second value of the inbound path preference attribute based on the received first value and the determined link speed; advertise the subnet to the third network device in association with the second value of the inbound path preference attribute; and route a data packet from the third network device to the second network device in accordance with a routing table comprising a routing entry based on the first value of the inbound path preference attribute.

In various embodiments, the network configuration logic may further be configured to set an outbound path preference attribute of the routing protocol for the subnet at the network device based on the first value of the inbound path preference attribute of the routing protocol.

In various embodiments, the logic stored on the storage medium includes an agent; the agent autonomously performs the operations, resulting in the routing table for the network device; and the routing table includes a plurality of routing entries corresponding to a plurality of other network devices in a network that comprises the network device.

In various embodiments, the network configuration logic may further be configured to initiate peering with the third network device upon initial connection to the third network device; authenticate the third network device based on a secure unique device identifier (SUDI) of the third network device; and responsive to the authentication, perform the advertising of the subnet to the third network device.

In various embodiments, the routing protocol is Border Gateway Protocol (BGP) and the inbound path preference attribute is a multi-exit discriminator (MED) attribute of BGP.

In various embodiments, the routing protocol is Open Shortest Path First (OSPF) and the inbound path preference attribute is a path cost metric of OSPF.

In various embodiments, the routing protocol is used by the network device both to advertise subnets and determine routes in a network comprising the network device.

In various embodiments, determining the second value of the inbound path preference attribute based on the received first value and the determined link speed includes applying the determined link speed to a first function, resulting in an intermediate value; and applying the intermediate value and the first value to a second function, resulting in the second value.

In various embodiments, the first function is an inverse logarithmic function, and the second function is an addition function.

In various embodiments, the network configuration logic may further be configured to receive, from a remote computing device, an update to the first function, wherein applying the determined link speed to the first function comprises applying the determined link speed to the updated first function.

In various embodiments, a network fabric includes a plurality of network devices, where each network device of the plurality of network devices includes a processor and a non-transitory computer-readable storage medium having stored thereon network configuration logic executable by the processor. In various embodiments, the network fabric performs operations of the network configuration logic stored at the plurality of network devices, and the operations may include determining a first link speed of a first link between a first network device and a second network device of the plurality of network devices, wherein the first network device and the second network device are connected by a first physical cable; determining a first value of an inbound path preference attribute of a routing protocol for a subnet advertised by the first network device to the second network device based on the first link speed; determining a second link speed of a second link between the second network device and a third network device of the plurality of network devices, wherein the second network device and third network device are connected by a second physical cable; determining a second value of the inbound path preference attribute of the routing protocol for the subnet, wherein determining the second value is based on the first value and the second link speed; advertising, by the second network device, the subnet to the third network device based on the determined second value of the inbound path preference attribute; and configuring a routing table in the network fabric based on the determined second value of the inbound path preference attribute of the routing protocol.

In various embodiments, the operations further include routing a data packet through the network fabric based on the configured routing table.

In various embodiments, configuring the routing table includes setting an outbound path preference attribute of the routing protocol for the subnet at the third network device based on the determined second value of the inbound path preference attribute of the routing protocol.

In various embodiments, the plurality of network devices comprises a plurality of switches configured in a spine-leaf topology.

In various embodiments, the first network device and third network device are leaf switches in the spine-leaf topology and the second network device is a spine switch in the spine-leaf topology.

In various embodiments, the routing protocol is Border Gateway Protocol (BGP) and the inbound path preference attribute is a multi-exit discriminator (MED) attribute of BGP.

In various embodiments, determining the second value of the inbound path preference attribute includes applying the second link speed to an inverse logarithmic function, resulting in an intermediate value; and adding the intermediate value to the first value, resulting in the second value.

In various embodiments, a network configuration method includes receiving, by a first network device, from a second network device, an advertisement of a subnet, the advertisement comprising a first value of an inbound path preference attribute of a routing protocol; determining, by the first network device, a link speed of a link between the first network device and a third network device; determining, by the first network device, a second value of the inbound path preference attribute based on the determined link speed and the first value of the inbound path preference attribute; advertising, by the first network device, the subnet to the third network device in association with the second value of the inbound path preference attribute; determining, by the first network device, a value of an outbound path preference attribute of the routing protocol based on the first value of the inbound path preference attribute; adding, by the first network device, a routing entry corresponding to the second network device and the subnet and comprising the value of the outbound path preference attribute, to a routing table of the first network device; and routing, by the first network device, a data packet from the third network device to the second network device in accordance with the routing entry.

In various embodiments, the routing protocol is Border Gateway Protocol (BGP), the inbound path preference attribute is a multi-exit discriminator (MED) attribute of BGP, and the outbound path preference attribute is a local preference (LP) attribute of BGP.

In various embodiments, determining, by the first network device, the value of the outbound path preference attribute of the routing protocol based on the first value of the inbound path preference attribute, includes applying the first value of the inbound path preference attribute to a conversion function, wherein lower values of the inbound path preference attribute applied to the conversion function result in higher values of the outbound path preference attribute resulting from the conversion function.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a networking system in accordance with various embodiments of the disclosure.

FIG. 2 is a conceptual depiction of a communication layer architecture in accordance with various embodiments of the disclosure.

FIG. 3 is a schematic block diagram of network switches in a spine-leaf topology in accordance with various embodiments of the disclosure.

FIG. 4 is a schematic block diagram of a network device in accordance with various embodiments of the disclosure.

FIG. 5 is a flowchart depicting a process for connecting a network device in accordance with various embodiments of the disclosure.

FIG. 6 is a flowchart depicting a process for route determination in accordance with various embodiments of the disclosure.

FIG. 7 is a flowchart depicting a process for configuring a network fabric in accordance with various embodiments of the disclosure.

FIG. 8 is a flowchart depicting a process for constructing routing tables in accordance with various embodiments of the disclosure.

FIG. 9 is a flowchart depicting a process for updating a path preference attribute value determination logic in accordance with various embodiments of the disclosure.

FIG. 10 is a conceptual block diagram of a device suitable for configuration with the network configuration logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

Configuring network devices can be complex and time-consuming, and can lead to errors that reduce the performance of the network that includes the configured network devices. For example, the network can include suboptimal cabling among network devices, and this in combination with poor implementation of routing protocols can cause the network to use lower-bandwidth links than are available on the network, leading to worse performance (e.g., increased latency). Furthermore, traditional network configuration typically involves manual configuring by specialists, as well as routine updating to maintain the functioning of the network. Traditional network configuration also typically employs various protocols to provide networking functionality, such as one protocol to advertise the reachability of services and another protocol to resolve multiple paths, discriminate link costs, and so on. Each involved protocol can be limited, such as Border Gateway Protocol (BGP), which is not aware of the bandwidths of links in a network.

Techniques described herein provide for self-arranging network devices that autonomously configure the network those network devices comprise, including peering, connecting, and transmitting data. Each network device includes an agent that autonomously performs network configuration operations, such as constructing a routing table for the network device, from advertising routes, to determining link bandwidths, to identifying optimal paths, to setting routing protocol attributes, to routing data packets. As used herein, a “network configuration logic” can include the network device, the agent, and/or other software and/or techniques relating to autonomous network configuration, in various embodiments.

In some embodiments, an entity, such as a user, a group of users, a company, a university, or so on, can build a data center or other computing environment. Computing devices in the computing environment can connect to one another and/or the internet using a network fabric that includes a set of network devices. After being cabled and turned on, the network devices autonomously self-configure and initiate the network for the computing environment, determining optimized routes for the network. In various embodiments, an optimized route is a route from one network location to a second network location that uses the highest bandwidth path, e.g., a route that has the lowest latency out of all existing paths from the one network location to the second network location. In various embodiments, the network devices determine the optimized routes using fewer routing protocols than would traditionally be employed, without requiring a controller to program anything on the network devices, and without extending any of the routing protocols (e.g., adding one or more custom attributes to one or more of the routing protocols beyond those defined in the protocol's specification). Furthermore, in various embodiments, the network devices employ techniques to determine values for path preference attributes that accommodate vast increases in link speeds, enabling the techniques described herein to be used for the foreseeable future rather than requiring modifications whenever link speeds improve. Specifically, some embodiments described herein provide for path evaluation in networks that include links with link speeds into the tens of thousands of terabits per second. The techniques described herein determine routes among network devices autonomously, consistently, and dynamically without extending existing routing protocols, allowing for tremendous forward compatibility with future networking devices and links (e.g., cables) and optimizing around suboptimally configured underlay networks (e.g., physical configurations of network devices and cables).

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in-one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

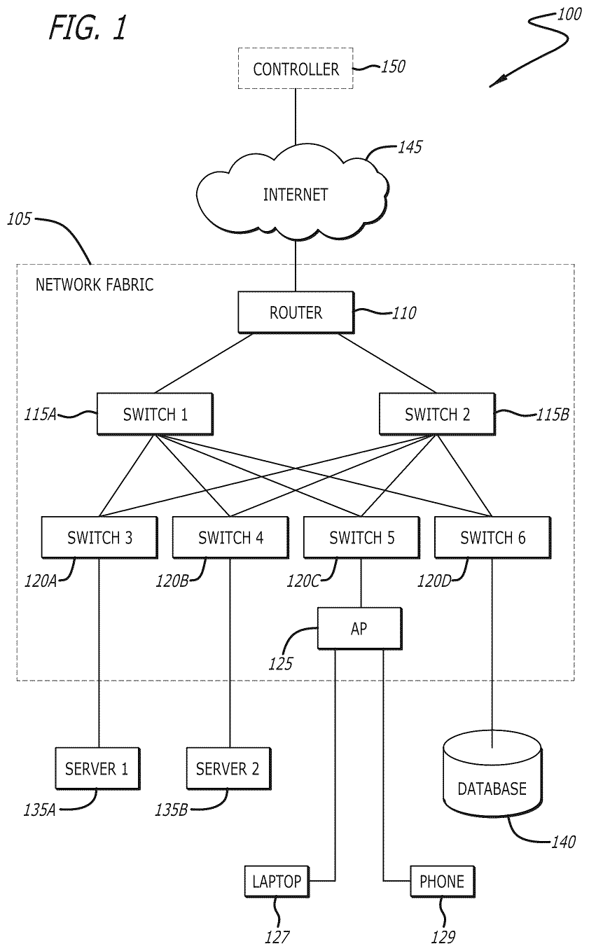

Referring to FIG. 1, a schematic block diagram of a networking system 100 in accordance with various embodiments of the disclosure is shown. The networking system 100 includes a network fabric 105. The network fabric 105 is a mesh of network devices that facilitates data transport. The network fabric 105 includes a router 110, switches 115A-B, switches 120A-D, and access point (AP) 125. In other embodiments, the network fabric 105 can include additional, fewer, or other components. For example, in some embodiments, the network fabric 105 does not include AP 125, or may include multiple access points. In some embodiments, the network fabric 105 includes a wireless local area network controller (WLC) that controls the operations of APs in the network fabric 105.

The router 110 is a network device that forwards data packets between different networks, such as between the network fabric 105 and another network, e.g., internet 145. Via the internet 145, the router 110 connects the network fabric 105 to external computing systems, such as a controller 150 in some embodiments. The controller 150 is a server or other computing device that sends instructions to the network fabric 105 in some embodiments, such as instructions to update a path preference attribute value determination logic, as described in further detail below. In various embodiments, the networking system 100 does not include the controller 150, and also may not include the internet 145.

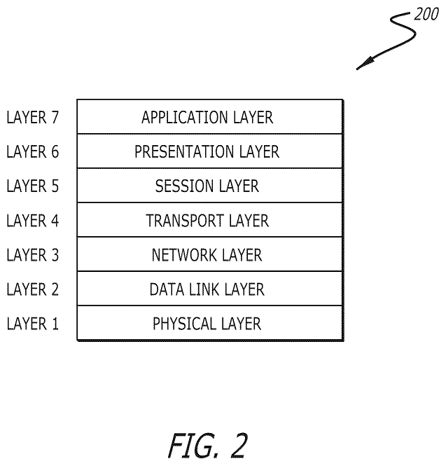

The switches 115A-B, 120A-D are network devices that connect computing devices within the same local area network (LAN) and forward data based on MAC addresses (described below with reference to FIG. 2). As illustrated in the example of FIG. 1, the switches 115A-B, 120A-D are arranged in a spine-leaf topology, where switches 115A-B are spines and switches 120A-D are leaves. The spine-leaf topology is a two-layer network architecture where leaf switches connect directly to servers and edge devices, while spine switches interconnect leaf switches. In a typical spine-leaf topology such as that illustrated in FIG. 1, every leaf connects to every spine, but spines do not connect to each other, and leaves do not connect to each other directly. This configuration ideally provides uniform low-latency and high-bandwidth paths between any two devices, with equal-cost multipath (ECMP) load balancing across the network fabric 105. As described herein, various embodiments of network fabrics 105 include physical configurations of switches that do not satisfy the ideal configuration of a spine-leaf network topology, such as embodiments where some links between switches have different bandwidths than others, or embodiments where some or all spine switches and/or some or all leaf switches are directly linked to one another. Various techniques put forth herein address problems that arise in such embodiments. In some embodiments, the switches of the network fabric 105 are configured according to different network architectures, such as a traditional three-tier core-aggregation-access topology. Various techniques put forth herein can be employed for network fabrics 105 with different network architectures without deviating from the principles set forth herein.

The AP 125 is a network device that facilitates Wi-Fi connections for various computing devices, such as but not limited to, a laptop 127 and a smartphone 129. Depending upon the embodiment, the AP 125 can provide wireless connectivity to any number of computing devices and any of a variety of wireless-enabled computing devices, such as laptops, smartphones, tablets, smartwatches, e-readers, desktop computers with Wi-Fi cards or adapters, smart televisions, streaming devices, smart speakers, home assistants, smart thermostats, smart plugs, smart lights, smart appliances, printers, projectors, scanners, point of sale systems, video conferencing systems, security cameras, wearable devices, smart doorbells, and so on.

The networking system 100 includes servers 135A-B and database 140. The network fabric 105 connects the servers 135A-B and database 140, as well as the laptop 127 and smartphone 129. Generally, the network fabric 105 connects end devices in a network to one another and, in some embodiments, to other networks. In networks conforming to a spine-leaf topology, leaf switches directly connect to end devices or access points. In the example of FIG. 1, switch 120A connects to server1 135A, switch 120B connects to server2 135B, switch 120C connects to AP 125, and switch 120D connects to database 140. Depending upon the embodiment, the networking system 100 can include additional, fewer, or other end devices than those illustrated in FIG. 1. For example, in some embodiments, the networking system 100 is a data center that does not include AP 125, laptop 127, or smartphone 129, but includes any number of servers 135 and/or databases 140, such as thousands of servers 135.

Although a specific embodiment for the networking system 100 is described above with respect to FIG. 1, any of a variety of systems and/or processes may be utilized in accordance with embodiments of the disclosure. For example, the networking system 100 may be configured into any number of various network topologies including different types of interconnected network devices and user devices. The elements depicted in FIG. 1 may also be interchangeable with other elements described herein as required to realize a particularly desired embodiment.

Referring to FIG. 2, a conceptual depiction of a communication layer architecture in accordance with various embodiments of the disclosure is shown. In many embodiments, the communication layer architecture 200 may be utilized to carry out various communications described or required herein. In still more embodiments, the communication layer architecture 200 may be configured as the open systems interconnection model, more commonly known as the OSI model. Likewise, the communication layer architecture 200 may have seven layers which may be implemented in accordance the OSI model.

In the embodiment depicted in FIG. 2, the communication layer architecture 200 includes a physical layer as a first layer (denoted as “Layer 1” in FIG. 2). The physical layer may serve as the foundational layer among the seven layers. The physical layer is responsible for the transmission and reception of raw, unstructured data bits over a physical medium, such as cables or wireless connections. At this layer, the focus is on the electrical, mechanical, and procedural characteristics of the hardware, including cables, connectors, and signaling. The primary goal is to establish a reliable and efficient means of physically transmitting data between devices. The physical layer does not concern itself with the meaning or interpretation of the data; instead, it concentrates on the fundamental aspects of transmitting binary information, addressing issues like voltage levels, data rates, and modulation techniques. Devices operating at the physical layer include network cables, connectors, repeaters, and hubs. The physical layer's successful operation is fundamental to the functioning of the entire OSI model, as it forms the bedrock upon which higher layers build their more complex communication protocols and structures.

In some embodiments, the communication layer architecture 200 may include a data link layer as a second layer (donated as “Layer 2” in FIG. 2). The data link layer may be configured to be primarily concerned with the reliable and efficient transmission of data between directly connected devices over a particular physical medium. Its responsibilities include framing data into frames, addressing, error detection, and, in some cases, error correction. The data link layer is divided into two sublayers: Logical Link Control (LLC) and Media Access Control (MAC). The LLC sublayer manages flow control and error checking, while the MAC sublayer is responsible for addressing devices on the network and controlling access to the physical medium. Ethernet is a common example of a data link layer protocol. This layer ensures that data is transmitted without errors and manages the flow of frames between devices on the same local network. Bridges and switches operate at the data link layer, making forwarding decisions based on MAC addresses. Overall, the data link layer plays a crucial role in creating a reliable point-to-point or point-to-multipoint link for data transmission between neighboring network devices.

In various embodiments, the communication layer architecture 200 may include a network layer as a third layer (denoted as “Layer 3” in FIG. 2). The network layer may be configured as a pivotal component responsible for the establishment of end-to-end communication across interconnected networks. Its primary functions include logical addressing, routing, and the fragmentation and reassembly of data packets. The network layer ensures that data is efficiently directed from the source to the destination, even when the devices are not directly connected. Internet Protocol (IP) is a prominent example of a network layer protocol. Devices known as routers operate at this layer, making decisions on the optimal path for data to traverse through a network based on logical addressing. The network layer abstracts the underlying physical and data link layers, allowing for a more scalable and flexible communication infrastructure. In essence, it provides the necessary mechanisms for devices in different network segments to communicate, contributing to the end-to-end connectivity that is fundamental to the functioning of the internet and other large-scale networks.

In additional embodiments, the communication layer architecture 200 may include a transport layer as a fourth layer (denoted as “Layer 4” in FIG. 2). The transport layer may be a critical element responsible for the end-to-end communication and reliable delivery of data between devices. Its primary objectives include error detection and correction, flow control, and segmentation and reassembly of data. Two key transport layer protocols are Transmission Control Protocol (TCP) and User Datagram Protocol (UDP). TCP ensures reliable and connection-oriented communication by establishing and maintaining a connection between sender and receiver, and it guarantees the orderly and error-free delivery of data through mechanisms like acknowledgment and retransmission. UDP, on the other hand, offers a connectionless and more lightweight approach suitable for applications where speed and real-time communication take precedence over reliability. The transport layer shields the upper-layer protocols from the complexities of the network and data link layers, providing a standardized interface for applications to send and receive data, making it a crucial facilitator for efficient, end-to-end communication in networked environments.

In further embodiments, the communication layer architecture 200 may include a session layer as a fifth layer (denoted as “Layer 5” in FIG. 2). The session layer may be configured to play a pivotal role in managing and controlling communication sessions between applications. It provides mechanisms for establishing, maintaining, and terminating dialogues or connections between devices. The session layer helps synchronize data exchange, ensuring that information is sent and received in an orderly fashion. Additionally, it supports functions such as checkpointing, which allows for the recovery of data in the event of a connection failure, and dialog control, which manages the flow of information between applications. While the session layer is not as explicitly implemented as lower layers, its services are crucial for maintaining the integrity and coherence of data during interactions between applications. By managing the flow of data and establishing the context for communication sessions, the session layer contributes to the overall reliability and efficiency of data exchange in networked environments.

In still further embodiments, the communication layer architecture 200 may include a presentation layer as a sixth layer (denoted as “Layer 6” in FIG. 2). The presentation layer may focus on the representation and translation of data between the application layer and the lower layers of the network stack. It can deal with issues related to data format conversion, ensuring that information is presented in a standardized and understandable manner for both the sender and the receiver. The presentation layer is often responsible for tasks such as data encryption and compression, which enhance the security and efficiency of data transmission. By handling the transformation of data formats and character sets, the presentation layer facilitates seamless communication between applications running on different systems. This layer may then abstract the complexities of data representation, enabling applications to exchange information without worrying about differences in data formats. In essence, the presentation layer plays a crucial role in ensuring interoperability and data integrity between diverse systems and applications within a networked environment.

In numerous embodiments, the communication layer architecture 200 may include an application layer as a seventh layer (denoted as “Layer 7” in FIG. 2). The application layer may serve as the interface between the network and the software applications that end-users interact with. It can provide a platform-independent environment for communication between diverse applications and ensures that data exchange is meaningful and understandable. The application layer can encompass a variety of protocols and services that support functions such as file transfers, email, remote login, and web browsing. It acts as a mediator, allowing different software applications to communicate seamlessly across a network. Some well-known application layer protocols include Hypertext Transfer Protocol (HTTP), File Transfer Protocol (FTP), and Simple Mail Transfer Protocol (SMTP). In essence, the application layer enables the development of network-aware applications by defining standard communication protocols and offering a set of services that facilitate robust and efficient end-to-end communication across networks.

Although a specific embodiment for the communication layer architecture 200 is described above with respect to FIG. 2, any of a variety of systems and/or processes may be utilized in accordance with embodiments of the disclosure. For example, various aspects described herein may reside or be carried out on one layer, or a plurality of layers.

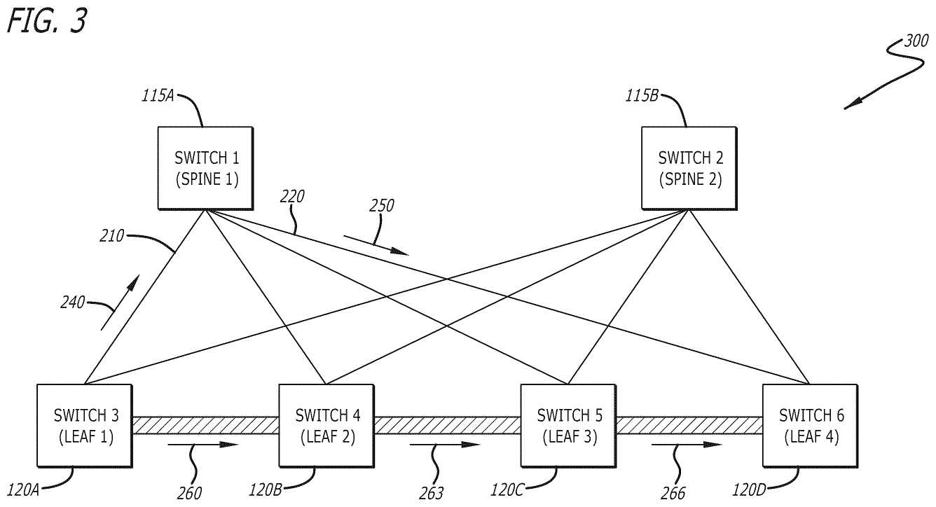

Referring to FIG. 3, a schematic block diagram of network switches in a spine-leaf topology 300 in accordance with various embodiments of the disclosure is shown. The spine-leaf topology 300 is part of a network fabric in various embodiments. The spine-leaf topology 300 includes six switches, switch1 115A, switch2 115B, switch3 120A, switch4 120B, switch5 120C, and switch6 120D. Switches 115A-B are spine switches and switches 120A-D are leaf switches. There are links among the switches 115A-B, 120A-D which in various embodiments are physical links, such as ethernet cables. Different links can have different maximum bandwidths for data transfer.

The spine-leaf topology 300 may not conform to the typical spine-leaf topology described above; specifically, in addition to every leaf connecting to each spine, the leaves are also connected directly to one another such that switch3 120A is linked to switch4 120B, switch4 120B is linked to switch5 120C, and switch5 120C is linked to switch6 120D, etc. Link 260 directly connects switch3 120A to switch4 120B, link 263 directly connects switch4 120B to switch5 120C, and link 266 directly connects switch5 120C to switch6 120D. Links 260, 263, 266 are illustrated as thicker than links connecting leaf switches to spine switches in FIG. 2, such as link 210 directly connecting switch3 120A to switch1 115A, link 210 directly connecting switch3 120A to switch1 115A or link 220 directly connecting switch1 115A to switch6 120D. This greater thickness of links 260, 263, 266 indicates that links 260, 263, 266 have greater bandwidth than links connecting leaf switches to spine switches in the example of the figure.

In certain embodiments, links 260, 263, 266 can have a bandwidth, or data transfer rate, of 400 G (gigabits per second), and all other links (e.g., link 210, link 220) have a bandwidth of 100 G. As such, in the embodiment depicted in FIG. 3, the links between leaf switches are four times as fast as links between leaf switches and spine switches. According to various traditional route determination techniques, e.g., according to various implementations of various routing protocols, a number of hops (or links travelled) between devices is prioritized over bandwidth when selecting a route. As such, according to various traditional route determination techniques, a traditional system would choose to transfer data from switch3 120A to switch6 120D through switch1 115A or switch2 115B, as either option passes the data along “hops,” (or across two links) rather than passing the data from switch3 120A to switch4 120B, from switch4 120B to switch5 120C, and from switch5 120C to switch6 120D, as that option requires traversal over three hops (or over links 260, 263, 266). However, due to the significantly greater bandwidth of links 260, 263, 266, the network should transfer data along link from switch3 120A to switch4 120B, link 263 from switch4 120B to switch5 120C, and link 266 from switch5 120C to switch6 120D, rather than along link 210 from switch3 120A to switch1 115A, and link 220 from switch1 115A to switch6 120D (or similarly through switch2 115B).

As described below, autonomous bandwidth-aware network configuration techniques enable the network to autonomously choose the path along links 260, 263, 266 over the path along links 240, 250, despite the former including a greater number of hops, because of the relative bandwidths of the two paths. This is beneficial as using the path along links 260, 263, 266 takes advantage of the greater bandwidth provided thereby, which produces benefits such as reduced latency on the network. As a second example, the techniques described herein can also address problems with network configuration situations in embodiments other than that illustrated in the example of FIG. 3, such as embodiments where link 260 has a bandwidth of 10 G. In such an embodiment, where link 240 has a bandwidth of 100 G and a link from switch1 115A to switch4 120B has a bandwidth of 100 G, the techniques described herein would select the path through switch1 115A rather than the direct connection from switch3 120A to switch4 120B for routing data, despite the greater number of hops, because the direct connection has a lower bandwidth. As a third example, the techniques described herein can also address problems with network configuration situations in embodiments such as where two equal-length paths through the network, in terms of hops, have different cumulative bandwidths; the techniques described herein provide for the route selection of the path with a higher bandwidth.

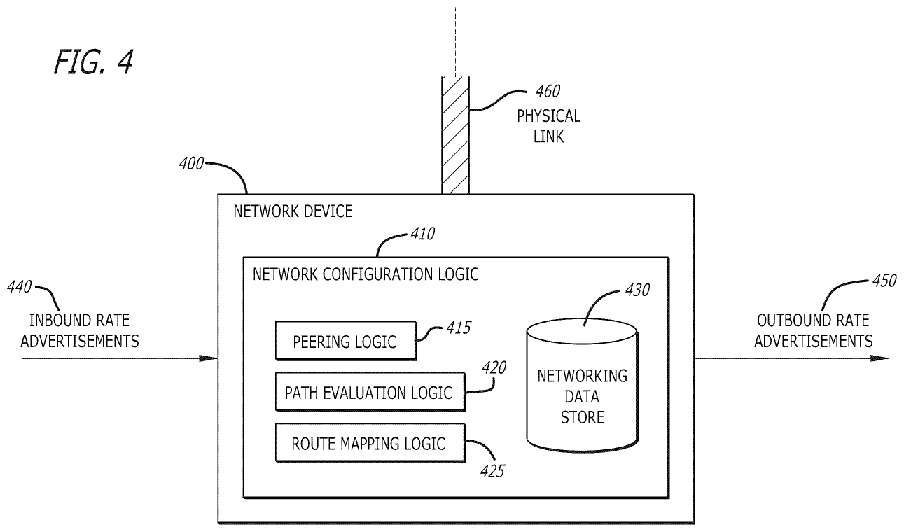

Referring to FIG. 4, a schematic block diagram of a network device in accordance with various embodiments of the disclosure is shown. The network device 400 is any of a variety of network devices, depending upon the embodiment, such as a switch, a router, an access point, or so on. The network device 400 is connected to at least one other computing device by a physical link 460. The network device 400 includes a network configuration logic 410 that performs some or all operations described herein, depending on the embodiment. The network configuration logic 410 includes a peering logic 415, a path evaluation logic 420, a route mapping logic 425, and a networking data store 430. In other embodiments, the network configuration logic 410 can include additional, fewer, or other logical components than those described herein, and/or functionality of logical components described herein can be redistributed, without departing from the principles set forth herein. In various embodiments, some or all functionality described with reference to the network configuration logic 410 is performed by an agent operating on the network device 400. In various embodiments, the networking data store 430 is not part of the network configuration logic 410, e.g., is stored on the network device 400 separately from the network configuration logic 410 and/or is logically separate to, but communicatively coupled with, the network configuration logic 410.

The network device 400 receives inbound route advertisements 440 from, and sends outbound route advertisements 450 to, neighboring network devices, e.g., network devices with physical links (e.g., physical link 460) to the network device 400. Network devices exchange route advertisements to share routing information among peers, such as subnets to which there are paths through a network device. The network device 400 evaluates inbound route advertisements 440 to decide which paths to install in its routing table, and shares outbound route advertisements 450 to spread reachability information, e.g., paths, among network devices in a network that includes the network device 400. Some or all functionality relating to receiving inbound route advertisements 440 and sending outbound route advertisements 450 can be performed by the network configuration logic 410 in accordance with various embodiments.

The peering logic 415 performs operations related to initializing, discovering, authenticating, and linking to neighboring network devices. When the network device 400 is turned on, the peering logic 415 autonomously initializes the network device 400 by generating an autonomous system number (ASN) for itself and uses a routing protocol, such as external border gateway protocol (eBGP), to discover and begin to peer to directly connected neighbors. In various embodiments, the peering logic 415 authenticates the neighboring network devices. In an embodiment, the peering logic 415 authenticates a neighboring network device using transport layer security (TLS) to authenticate a secure unique device identifier (SUDI) provided by the neighboring network device. Once the neighboring network device is authenticated, the peering logic 415 links the network device 400 to the neighboring network device. The network device 400 receives inbound route advertisements 440 from the neighboring network device and can send outbound route advertisements 450 to the neighboring network device via the peering logic 415.

The path evaluation logic 420 performs operations related to evaluating a path (e.g., to a subnet) such that the path can be compared to other paths for selection to route data packets. The path evaluation logic 420 determines the bandwidth of physical links to neighboring network devices, such as a neighboring network device connected to the network device 400 by physical link 460. The path evaluation logic 420 evaluates paths by scoring the paths based on the bandwidths of links included in the paths, in accordance with any of a variety of embodiments as described below. The path evaluation logic 420 may also score paths based on received scores, in accordance with any of a variety of embodiments described below. For example, the score can be a value of a path preference attribute of a routing protocol, such as the multi-exit discriminator (MED) attribute of BGP in some embodiments. In some embodiments, the routing protocol is Open Shortest Path First (OSPF) and the path preference attribute is a path cost metric of OSPF.

The path evaluation logic 420 also identifies paths to advertise, e.g., paths that include the network device 400, and generates path scores (e.g., MED values) for the identified paths to be included in outbound route advertisements sent by the peering logic 415. The path evaluation logic 420 can use any of a variety of techniques to generate path scores, such as those described below. By consistently generating path scores based on link bandwidths and received path scores, the path evaluation logic 420 can propagate bandwidth-aware path scores through the network, enabling network devices in a network to construct routing tables that include the highest bandwidth paths.

The route mapping logic 425 evaluates path scores (e.g., MED values) to determine which paths to use to route data packets. In some embodiments, the route mapping logic 425 constructs a routing table for the network device 400 based on route information including path scores such that highest-bandwidth paths are included in the routing table. For example, the route mapping logic 425 may generate route maps based on information from the path evaluation logic 420 such that paths are advertised by the network device 400 using particular path scores determined by the path evaluation logic 420. The route mapping logic 425 may set values for one or more routing protocol attributes using route maps.

The networking data store 430 stores data of the network device 400, such as routing protocol attribute values, routing tables, MAC address tables, port configuration data, received route advertisements, and so on. Depending upon the embodiment, the networking data store can be relational or non-relational, or structured in another form. The peering logic 415, path evaluation logic 420, and route mapping logic 425 can read from and write to the networking data store 430, in various embodiments.

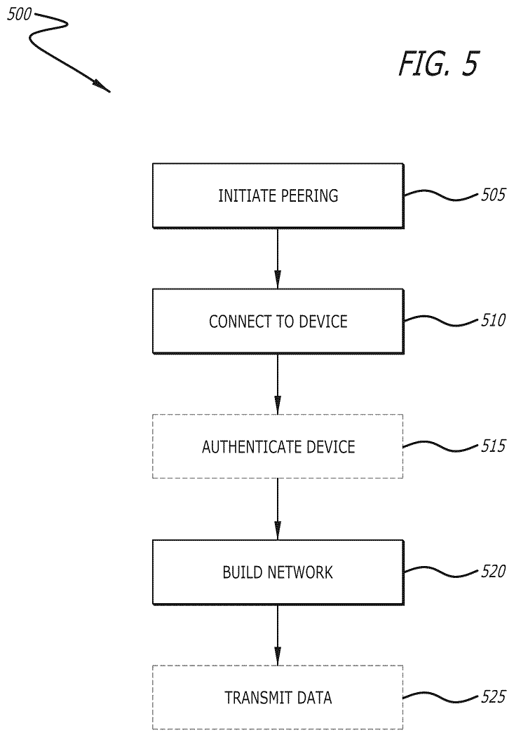

Referring to FIG. 5, a flowchart depicting a process 500 for connecting a network device in accordance with various embodiments of the disclosure is shown. The process may be performed by network configuration logic of the network device, for example. However, some or all steps may be performed by other entities or components. In addition, some embodiments may perform the steps in parallel, perform the steps in different orders, perform a subset of the described steps, or perform additional steps, without departing from the principles set forth herein.

In various embodiments, the network configuration logic initiates peering (block 505). As described above, in various embodiments, when the network device is turned on, the network configuration logic autonomously initializes the network device by generating an autonomous system number (ASN) for itself and uses a routing protocol, such as external border gateway protocol (eBGP), to discover and begin to peer to directly connected neighbors. In other words, the network configuration logic connects to a neighboring network device (block 510). In various embodiments, when connecting to a neighboring network device, the network configuration logic authenticates the neighboring network device (block 515). In an embodiment, the network configuration logic authenticates the neighboring network device using transport layer security (TLS) to authenticate a secure unique device identifier (SUDI) provided by the neighboring network device.

In various embodiments, the network configuration logic builds the network (block 520). Building the network, e.g., filling a routing table for the network device, is described in further detail below. In various embodiments, once the routing table is configured, the network configuration logic can transmit data over the network (block 525). For example, the network device may receive a data packet from an end device or another network device, determine a link along which to send the data packet based on the routing table, and then send the data packet along the determined link.

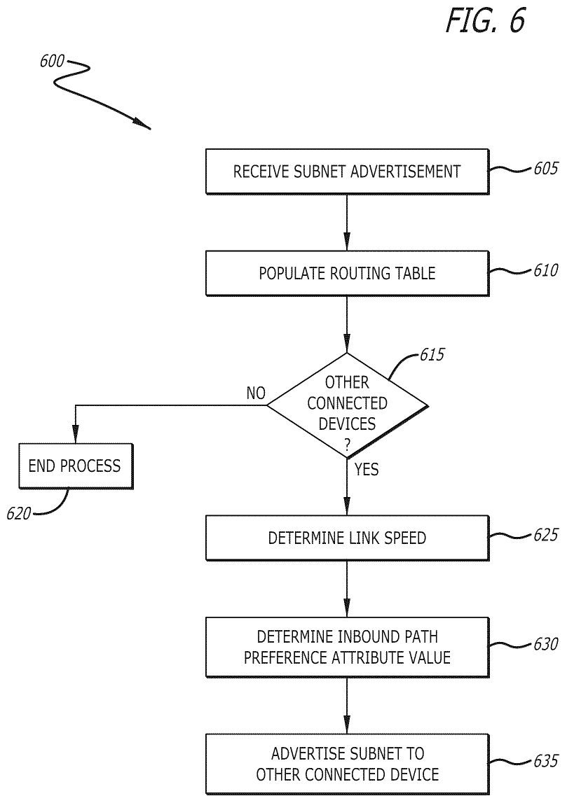

Referring to FIG. 6, a flowchart depicting a process 600 for route determination in accordance with various embodiments of the disclosure is shown. The process may be performed by network configuration logic of the network device, for example. However, some or all steps may be performed by other entities or components. In addition, some embodiments may perform the steps in parallel, perform the steps in different orders, perform a subset of the described steps, or perform additional steps, without departing from the principles set forth herein.

A network device receives a subnet advertisement from a neighboring network device (block 605), e.g., another network device peered to the network device. The subnet advertisement is a message from the neighboring network device that indicates the neighboring network device has an interface to a particular subnet (e.g., network prefix). The subnet is a range of destinations, e.g., internet protocol (IP) addresses, to which the neighboring network device can route received data. In various embodiments, the subnet advertisement includes a path preference attribute value. In some embodiments, the path preference attribute is specifically an inbound path preference attribute, such as the MED attribute of BGP. The value of the path preference attribute indicates a path cost of the route indicated by the subnet advertisement. Depending upon the embodiment, a lower path cost can be more favorable than a higher path cost, or vice versa. For example, lower values of the MED attribute of BGP are more favorable than higher values of the MED attribute, e.g., for two routes to a particular subnet that exist in a network, a network device will choose the route with the lower MED attribute value.

As described in further detail below, the path preference attribute value of the received subnet advertisement is determined using a path preference attribute value determination logic. In various embodiments, the path preference attribute value determination logic is consistent across all network devices in a given network, e.g., a particular network fabric. As such, the path preference attribute value determination logic, given the same input, produces the same output path preference attribute value, regardless of which network device in the network executes the function. In this manner, the path preference attribute value can be used to consistently evaluate routes across network devices in the network. Traditionally, many path preference attributes, such as the MED attribute, are non-transitive, meaning they are not propagated through the network. Rather, traditionally, the MED attribute is included in a subnet advertisement by one network device to indicate to another network device a degree of preference (or favorability) for the corresponding route. The techniques provided herein beneficially employ a path preference attribute (e.g., a traditionally non-transitive attribute) to consistently determine path costs through a network, building on path preference attribute values at each hop of the corresponding route as it is advertised through the network.

More specifically, in various embodiments, the path preference attribute value determination logic takes as input a received path preference attribute value and a link speed. In many embodiments, the received path preference attribute value is the path preference attribute value included in the received subnet advertisement. In embodiments where the network device determines a path preference attribute value for a subnet accessible directly from the network device, e.g., an end device directly connected to the network device, the received path preference attribute value may be zero, or some other constant. In some embodiments, the received path preference attribute value may instead be calculated by the network device based on a link speed of a link to the end device. A link speed is a bandwidth measurement, e.g., a data rate, such as a number of gigabits transmittable by a link per second. Depending on the embodiment, any units of bit quantity and time may be used for the data rate, such as bits, kilobits, megabits, gigabits, terabits, or so on, and seconds, microseconds, milliseconds, or so on.

The network device determines the link speed based on network configuration logic that measures the bandwidth of a link. In various embodiments, the link speed is a value indicating the measured bandwidth of a link from the network device to another network device. Depending upon the embodiment, the other network device can be the network device from which the network device received the subnet advertisement, or can be another network device in the network. The path preference attribute value determination logic applies the received path preference attribute value and the determined link speed to generate an output path preference attribute value. As described in further detail below, the output path preference attribute value is used by the network device to advertise the route to the subnet advertised by the received subnet advertisement to another network device, e.g., a third network device in the network that is neither the network device nor the network device that sent the subnet advertisement.

In various embodiments, the path preference attribute value determination logic applies the determined link speed to a first function, which results in an intermediate value. The path preference attribute value determination logic then applies the intermediate value and the received path preference attribute value to a second function, which outputs the output path preference attribute value. In some embodiments, the first function is an inverse logarithmic function, and the second function is an addition operation. In other embodiments, the first function and/or second function may be different. For example, in some unpreferred embodiments, the first function may be a linear function. In many embodiments, the first function being an inverse logarithmic function is preferrable because it scales better than a linear function, e.g., continues to work with higher link speeds than would a linear function. As such, the inverse logarithmic function makes the path preference attribute value determination logic usable further into the future, e.g., usable with future network devices and links of higher bandwidth.

In this manner, the network device can consistently generate and spread bandwidth-aware end-to-end path costs throughout a network, enabling network devices of the network to autonomously evaluate routes and, as described below, build routing tables that include the optimal routes (e.g., highest bandwidth of all possible routes) to subnets that are connected to the network. Furthermore, by employing the path preference attribute of a routing protocol both to advertise reachability of services and evaluate paths, the network device is better able to autonomously configure the network, e.g., build its routing table. Traditional networks may employ, for example, BGP to advertise the reachability of services, and use a separate routing protocol, such as interior gateway protocol (IGP) or open shortest path first (OSPF), to evaluate paths. The techniques provided herein enable the use of one routing protocol, such as just BGP, or just OSPF, to perform operations related to network configuration, such as route advertisement and path evaluation. Furthermore, the techniques provided herein do not require the extension of a routing protocol to perform described operations.

In various embodiments, after receiving the subnet advertisement (block 605), the network device populates its routing table (block 610). Depending upon the embodiment, the network device may receive multiple subnet advertisements that advertise routes to the same subnet. In such multipath situations, the network device may choose the best or more optimal route (e.g., the path with the more favorable path preference attribute value, such as a lower MED value) to include in the routing table. The routing table of the network device is a data structure stored in the network device that contains information about how to forward data packets to their destinations. Each entry in the table typically includes a destination network prefix (subnet), subnet mask, next-hop IP address, outgoing interface, and a metric or administrative distance that indicates the preference or path cost of the route. In various embodiments, the routing table is dynamically updated by routing protocols (e.g., BGP, OSPF). When a data packet arrives, the network device consults the routing table to determine the best path based on the longest prefix match and forwards the data packet accordingly.

In some embodiments, the network device converts a path preference attribute value into another value before adding a route to the routing table. For example, in various embodiments, the network device converts an inbound path preference attribute value into an outbound path preference attribute value using a conversion function, and adds the route to the routing table using the outbound path preference attribute value. As a specific example, the inbound path preference attribute may be the MED attribute of BGP, and the outbound path preference attribute may be the local preference (LP) attribute of BGP. Lower MED attribute values are more favorable over higher MED attribute values, but higher LP attribute values are more favorable over lower LP attribute values. As such, the conversion function may convert lower MED attribute values into higher LP attribute values, such that the LP attribute values reflect the degree of preference indicated by the MED attribute values. In various embodiments, the network device converts inbound path preference attribute values into outbound path preference attribute values due to a path selection attribute priority of the routing protocol. For example, in BGP, local preference values have higher priority for path selection than MED values. As a general example of the path selection attribute priority in BGP, a first route with a local preference value of 200 and a MED value of 100 would be selected over a second route with a local preference value of 190 and a MED value of 50. By converting the inbound path preference attribute value to an outbound path preference attribute value with a higher path selection attribute priority, the network device configures the network such that the selected routes included in the routing table reflect those with the most favorable path costs determined based on the inbound path preference attribute. In various embodiments, the network device populates the routing table using route maps, e.g., uses a route map to set a local preference value of a route through a neighboring network device to a subnet.

In various embodiments, the network device determines whether there are other network devices connected to the network device, e.g., neighboring network devices, besides the neighboring network device from which the network device received the subnet advertisement (block 615). If there are no other neighboring network devices, the network device ends the process (block 620). That is, if there are no other network devices to which the subnet advertised by the subnet advertisement should be advertised by the network device, the network device does not advertise the subnet. However, in various embodiments, if there are one or more neighboring network devices besides the neighboring network device from which the network device received the subnet advertisement, the network device generates a subnet advertisement for each of those one or more neighboring network devices, e.g., performs some or all operations of blocks 625, 630, and 635, described below, for each of those one or more neighboring network devices.

In various embodiments, the network device determines a link speed to a neighboring network device (block 625). As described above, the network device includes logic to determine the link speed, e.g., the bandwidth of the link connecting the network device to the neighboring network device. The network device then determines a new path preference attribute value for the subnet advertisement to the neighboring network device (block 630). In various embodiments, the network device determines a new inbound path preference attribute value, e.g., a MED value, based on the received path preference attribute value of block 605 and the determined link speed of block 625. In various embodiments, the network device then advertises the subnet to the neighboring network device to which the network device is connected by the link (block 635). The network device sends a new subnet advertisement, including the new path preference attribute value, to the neighboring network device via the link. In this manner, the network device employs a routing protocol to autonomously and consistently generate and spread bandwidth-aware end-to-end path costs throughout a network.

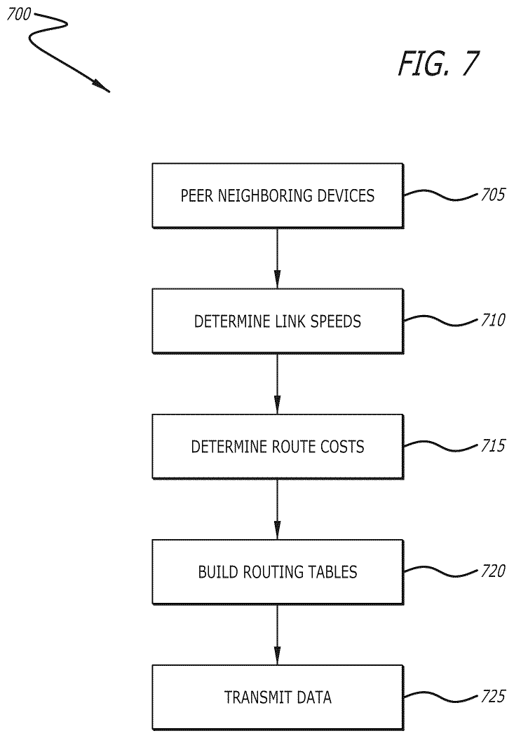

Referring to FIG. 7, a flowchart depicting a process 700 for configuring a network fabric in accordance with various embodiments of the disclosure is shown. The network fabric includes a plurality of network devices, such as a set of switches in a spine-leaf topology, in some embodiments. Network configuration logic at each network device in the network fabric performs network configuration operations to configure the respective network device, such as operations of the process 600 of FIG. 6, and cumulatively the network configuration logic configures the network fabric overall. The process 700 may be performed by network configuration logic of network device, but in other embodiments, some or all steps may be performed by other entities or components. In addition, some embodiments may perform the steps in parallel, perform the steps in different orders, perform a subset of the described steps, or perform additional steps, without departing from the principles set forth herein.

In various embodiments, the network fabric, e.g., network configuration logic at each network device of the network fabric, peers to neighboring network devices (block 705). Each network device in the network fabric is linked to at least one other network device in the network fabric. The network devices each perform peering operations, e.g., those described above with reference to FIG. 5, and cumulatively the network fabric peers neighboring network devices to one another.

In various embodiments, the network fabric, e.g., network configuration logic at each network device of the network fabric, determines link speeds (block 710). In various embodiments, each network device in the network fabric determines the link speed of some or all links from the network device to neighboring network devices. As described above, the network devices determine link speeds as part of generating path preference attribute values for advertising subnets. Cumulatively, the network fabric determines link speeds as part of configuring the network. For example, the network fabric determines a first link speed of a first link between a first network device and a second network device, which may be conducted by network configuration logic of the first network device; and the network fabric determines a second link speed of a second link between the second network device and a third network device, which may be conducted by network configuration logic of the second network device.

In various embodiments, the network fabric, e.g., network configuration logic at each network device of the network fabric, determines route costs (block 715). In various embodiments, each network device in the network fabric determines a route cost (or path cost) to one or more neighboring network devices to which the network device advertises routes to one or more subnets. Each of these subnet advertisements is based on a determined link speed, e.g., the link speed of a link from the advertising network device to the neighboring network device receiving the subnet advertisement, and some or all of these subnet advertisements may also be based on a received path preference attribute value, depending on the embodiment. Cumulatively, the network fabric determines end-to-end route costs for routes in the network fabric. For example, the network fabric determines a first value of an inbound path preference attribute of a routing protocol for a subnet advertised by a first network device to a second network device, and the network fabric determines a second value of the inbound path preference attribute of the routing protocol for the subnet advertised by the second network device to a third network device. The end-to-end path cost from the first network device to the second network device is reflected in the path cost at the second network device, and the end-to-end path cost from the first network device to the third network device is reflected in the path cost at the third network device.

In various embodiments, the network fabric, e.g., network configuration logic at each network device of the network fabric, builds routing tables (block 720). As described above, based on routes exposed to a network device, the network device builds a routing table with the most favorable (e.g., best path cost) routes. In various embodiments, each network device autonomously builds its own routing table based on the routes exposed to the network device, e.g., based on subnet advertisements received by the network device, and in some embodiments also based on end devices connected to the network device. In some embodiments, the network fabric converts inbound path preference attribute values into outbound path preference attribute values, as described above with reference to FIG. 6, for use in route entries in the routing table, e.g., to set an LP attribute value of a route in the routing table via a route map.

In various embodiments, the network fabric transmits data based on the network configuration implemented by the network configuration logic (block 725). In various embodiments, each network device receives data packets, determines where to route the data packets based on the routing table of the network device, and sends the data packet to a neighboring network device or end device accordingly. Cumulatively, the network fabric exposes networking functionality based on the network configuration implemented by operations of blocks 705, 710, 715, and 720. For example, in various embodiments, the network fabric can enable end devices, such as servers, databases, user devices (e.g., laptops, desktops, smartphones, and so on, via an access point), etc., to communicate with one another (e.g., send data packets to one another), and/or to communicate with computing devices over the internet (to which the network fabric may be connected, e.g., via a router that may be part of the network fabric). Overall, the network fabric autonomously initiates, self-configures, and begins providing networking functionality.

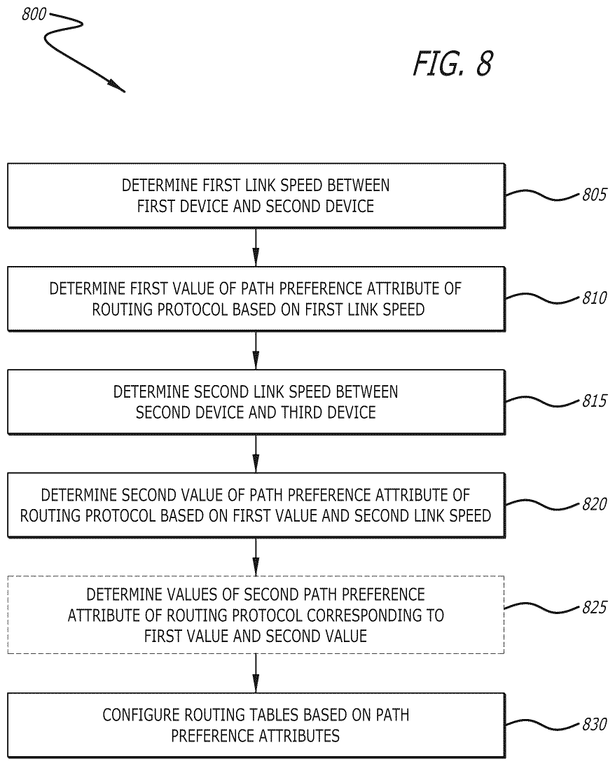

Referring to FIG. 8, a flowchart depicting a process 800 for constructing routing tables in accordance with various embodiments of the disclosure is shown. The process 800 may be performed by network configuration logic of one or more network devices of a network fabric, for example. However, some or all steps may be performed by other entities or components. In addition, some embodiments may perform the steps in parallel, perform the steps in different orders, perform a subset of the described steps, or perform additional steps, without departing from the principles set forth herein.

The network configuration logic determines a first link speed between a first network device and a second network device (block 805). As described above, the network configuration logic measures the bandwidth of a physical link between the first network device and second network device. The network configuration logic determines a first value of a path preference attribute of a routing protocol based on the first link speed (block 810). In some embodiments, the first value of the path preference attribute is additionally based on a received value of the path preference attribute, e.g., a value included in a received subnet advertisement. In some embodiments, the first value is generated by the network configuration logic for use in advertising a subnet directly interfacing with a particular network device, e.g., an end device linked to the network device executing at least some of the network configuration logic. In such embodiments, the first value of the path preference attribute may not be additionally based on a received value.

In various embodiments, the network configuration logic determines a second link speed between the second network device and a third network device (block 815). Similar to the above, the network configuration logic measures the bandwidth of a physical link between the second network device and third network device. The network configuration logic determines a second value of the path preference attribute of a routing protocol based on the second link speed (block 820). In various embodiments, the second value corresponds to a subnet advertisement by the second network device that advertises a route to a subnet via a neighboring network device, e.g., a neighboring network device from which the network device executing some or all of the network configuration logic received a subnet advertisement for the subnet. In such embodiments, the second value is additionally based on a received value of the path preference attribute included in the received subnet advertisement from the neighboring network device.

In some embodiments, the network configuration logic determines values of a second path preference attribute of the routing protocol that correspond to the first value and second value of the path preference attribute (block 825). For example, the path preference attribute may be an inbound path preference attribute, and the second path preference attribute may be an outbound path preference attribute. In some embodiments, the network configuration logic applies the first value and second value to a conversion function that produces corresponding values of the second path preference attribute.

In various embodiments, the network configuration logic configures routing tables based on the path preference attributes (e.g., the path preference attribute and/or the second path preference attribute) (block 830). In some embodiments, the network configuration logic adds a route entry to a routing table of a network device executing some or all of the network configuration logic based on a path preference attribute value and/or a second path preference attribute value. For example, in some embodiments the network configuration logic generates a route map that sets a path preference attribute value and/or second path preference attribute value in the routing table in association with a route. Each route entry is a data record that specifies how to forward data packets. In various embodiments, route entries in a routing table on a network device correspond to other network devices in a network that includes the network device. In various embodiments, after populating the routing tables of one or more network devices, the network configuration logic has completed network setup and the network devices are usable to transmit data, e.g., to forward data packets.

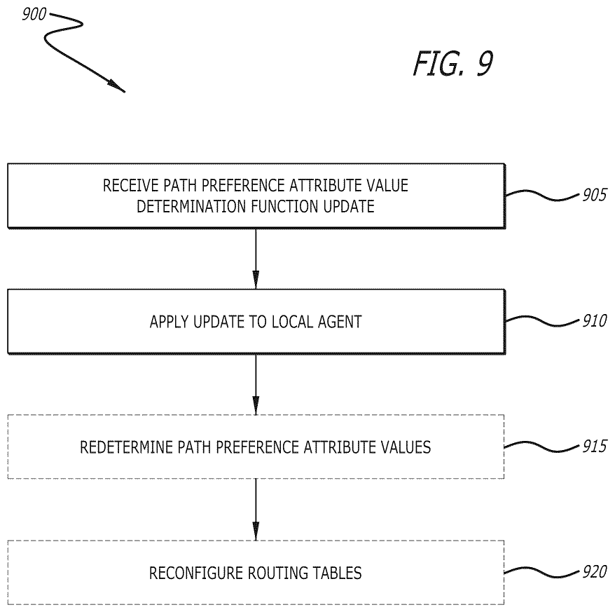

Referring to FIG. 9, a flowchart depicting a process 900 for updating a path preference attribute value determination logic in accordance with various embodiments of the disclosure is shown. The process may be performed by network configuration logic of a network device, for example. However, some or all steps may be performed by other entities or components. In addition, some embodiments may perform the steps in parallel, perform the steps in different orders, perform a subset of the described steps, or perform additional steps, without departing from the principles set forth herein.

In various embodiments, the network configuration logic receives a path preference attribute value determination logic update (block 905). In various embodiments, the network configuration logic receives the update from the controller 150, which may be a server or other computing device administered by an organization associated with a network device executing the network configuration logic. For example, a company that produces the network device may include in its computing environment the controller 150. The path preference attribute value determination logic update changes the path preference attribute value determination logic used by the network configuration logic to determine a path cost, e.g., a value of a path preference attribute of a routing protocol employed by the network configuration logic for path evaluation.

The path preference attribute value determination logic update can change some or all of the function, depending on the embodiment. For example, the update may replace an inverse logarithmic function applied to a link speed with another function, such as a linear equation. In some embodiments, the path preference attribute value determination logic update alternatively or additionally adds to the path preference attribute value determination logic, such as adding a constant. In some embodiments, the path preference attribute value determination logic update additionally or alternatively updates a conversion function that receives as input an inbound path preference attribute value, such as a MED value, and produces as output an outbound path preference attribute value, such as a local preference (LP) value. Generally, the conversion function is any function that converts lower values of the inbound path preference attribute value into higher values of the outbound path preference attribute. The update can adjust the conversion function to include the addition of a constant to the output value, in some embodiments.

In various embodiments, the network configuration logic applies the update to a local agent (block 910). As described above, in various embodiments, the network configuration logic includes an agent local to the network device that performs some or all operations described herein with reference to the network configuration logic. The agent uses the path preference attribute value determination logic in scoring paths in a network that includes the network device. The agent applies the update, adjusting or replacing some or all of the path preference attribute value determination logic. The network configuration logic uses the updated path preference attribute value determination logic for subsequent scoring of paths.

In various embodiments, the network configuration logic redetermines existing path preference attribute values (block 915). For example, the network device may recalculate a path cost for each path through the network device, in case the updated path preference attribute value determination logic changes which of multiple paths from a source to a destination is scored the most favorably (e.g., the lowest MED attribute value). In various embodiments, the network configuration logic reconfigures the routing tables (block 920), e.g., in response to determining a new path from a source to a destination is scored most favorably than a previous most favorably scored path from the source to the destination from before the update. The network configuration logic may update one or more values in the routing table, such as LP values, and/or may add or remove routes from the routing table, based on the updated path costs.

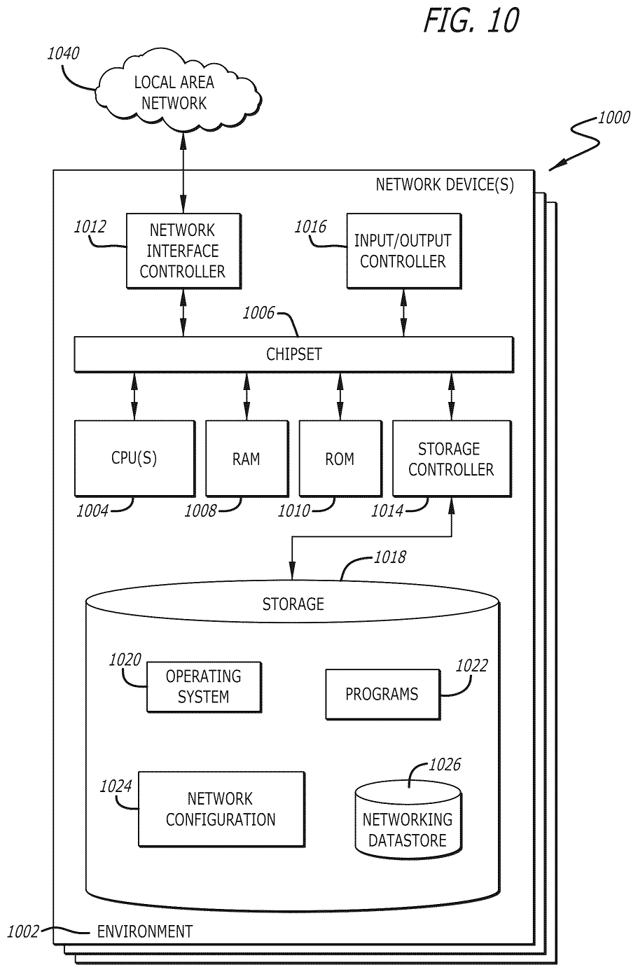

Referring to FIG. 10, a conceptual block diagram of a device suitable for configuration with the network configuration logic in accordance with various embodiments of the disclosure is shown. The embodiment of the conceptual block diagram depicted in FIG. 10 can illustrate a conventional server, switch, wireless LAN controller, AP, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an AP, a switch, an edge node, an ethernet interface, or a router in accordance with various embodiments of the disclosure. The device 1000 may, in many non-limiting examples, correspond to physical devices or virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000. In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020 and programs 1022 (e.g., applications). The storage 1018 can be connected to the environment 1002 through a storage controller 1014 connected to the chipset 1006. In various other embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and/or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as programs 1022 (e.g., an application) and transform the device 1000 by specifying how the processor(s) 1004 can transition between states, as described above. In some embodiments, the device 1000 has access to computer-readable storage media storing computer-executable instructions which, when executed by the device 1000, perform the various processes described herein. In certain embodiments, the device 1000 can also include computer-readable storage media having instructions stored thereupon for performing any of the other computer-implemented operations described herein.

In many further embodiments, the device 1000 may include a network configuration logic 1024. The network configuration logic 1024 can be configured to perform one or more of the various steps, processes, operations, and/or other methods that are described herein. The network configuration logic 1024 can be a set of instructions stored within a non-volatile memory that, when executed by the processor(s) 1004 can carry out these steps, etc. In some embodiments, the network configuration logic 1024 may be a client application that resides on a network-connected device, such as, but not limited to, a server, switch, an ethernet interface, personal or mobile computing device in a single or distributed arrangement. In numerous embodiments, when the device 1000 is configured as a network device, the network configuration logic 1024 may be configured to peer to another network device, determine a link speed, advertise a route to a resource (e.g., a subnet), set a routing protocol parameter, and construct a routing table.

In some embodiments, the storage 1018 can include a networking datastore 1026. The networking datastore 1026 can include values of routing protocol attributes, routing tables, route maps, link speeds, and/or other data relating to network configuration. For example, in some embodiments the networking datastore 1026 includes an autonomous system number of the device 1000.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Although a specific embodiment for a device suitable for configuration with the network configuration logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or APs.

Although the present disclosure has been described in certain specific aspects, many additional modifications and variations would be apparent to those skilled in the art. In particular, any of the various processes described above can be performed in alternative sequences and/or in parallel (on the same or different computing devices) in order to achieve similar results in a manner that is more appropriate to the requirements of a specific application. It is therefore to be understood that the present disclosure can be practiced other than specifically described without departing from the scope of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the scope of the present disclosure, as set forth in the appended claims, as might be apparent to those of ordinary skill in the art, are also encompassed by the present disclosure.

What is claimed is:

1. A network device, comprising:
a processor; and
a non-transitory computer-readable storage medium having stored thereon logic that, when executed by the processor, causes performance of operations comprising:
receiving, from a second network device, an advertisement for a subnet and a first value of an inbound path preference attribute of a routing protocol;
determining a link speed of a link between the network device and a third network device;
determining a second value of the inbound path preference attribute based on the received first value and the determined link speed;
advertising the subnet to the third network device in association with the second value of the inbound path preference attribute; and
routing a data packet from the third network device to the second network device in accordance with a routing table comprising a routing entry based on the first value of the inbound path preference attribute.

2. The network device of claim 1, the operations further comprising:
setting an outbound path preference attribute of the routing protocol for the subnet at the network device based on the first value of the inbound path preference attribute of the routing protocol.

3. The network device of claim 1, wherein the logic stored on the non-transitory computer-readable storage medium comprises an agent, the agent autonomously performs the operations, resulting in the routing table for the network device, and the routing table includes a plurality of routing entries corresponding to a plurality of other network devices in a network that comprises the network device.

4. The network device of claim 1, the operations further comprising:
initiating peering with the third network device upon initial connection to the third network device;
authenticating the third network device based on a secure unique device identifier (SUDI) of the third network device; and
responsive to the authentication, performing the advertising of the subnet to the third network device.

5. The network device of claim 1, wherein the routing protocol is Border Gateway Protocol (BGP) and the inbound path preference attribute is a multi-exit discriminator (MED) attribute of BGP.

6. The network device of claim 1, wherein the routing protocol is Open Shortest Path First (OSPF) and the inbound path preference attribute is a path cost metric of OSPF.

7. The network device of claim 1, wherein the routing protocol is used by the network device both to advertise subnets and determine routes in a network comprising the network device.

8. The network device of claim 1, wherein determining the second value of the inbound path preference attribute based on the received first value and the determined link speed comprises:
applying the determined link speed to a first function, resulting in an intermediate value; and
applying the intermediate value and the first value to a second function, resulting in the second value.

9. The network device of claim 8, wherein the first function is an inverse logarithmic function, and the second function is an addition function.

10. The network device of claim 8, the operations further comprising:
receiving, from a remote computing device, an update to the first function, wherein applying the determined link speed to the first function comprises applying the determined link speed to the updated first function.

11. A network fabric, comprising:
a plurality of network devices, wherein each network device of the plurality of network devices comprises a processor and a non-transitory computer-readable storage medium having stored thereon network configuration logic executable by the processor;
wherein the network fabric performs operations of the network configuration logic stored at the plurality of network devices, the operations comprising:
determining a first link speed of a first link between a first network device and a second network device of the plurality of network devices, wherein the first network device and the second network device are connected by a first physical cable;
determining a first value of an inbound path preference attribute of a routing protocol for a subnet advertised by the first network device to the second network device based on the first link speed;
determining a second link speed of a second link between the second network device and a third network device of the plurality of network devices, wherein the second network device and third network device are connected by a second physical cable;
determining a second value of the inbound path preference attribute of the routing protocol for the subnet, wherein determining the second value is based on the first value and the second link speed;
advertising, by the second network device, the subnet to the third network device based on the determined second value of the inbound path preference attribute; and
configuring a routing table in the network fabric based on the determined second value of the inbound path preference attribute of the routing protocol.

12. The network fabric of claim 11, further comprising:
routing a data packet through the network fabric based on the configured routing table.

13. The network fabric of claim 11, wherein configuring the routing table comprises:
setting an outbound path preference attribute of the routing protocol for the subnet at the third network device based on the determined second value of the inbound path preference attribute of the routing protocol.

14. The network fabric of claim 11, wherein the plurality of network devices comprises a plurality of switches configured in a spine-leaf topology.

15. The network fabric of claim 14, wherein the first network device and third network device are leaf switches in the spine-leaf topology and the second network device is a spine switch in the spine-leaf topology.

16. The network fabric of claim 11, wherein the routing protocol is Border Gateway Protocol (BGP) and the inbound path preference attribute is a multi-exit discriminator (MED) attribute of BGP.

17. The network fabric of claim 11, wherein determining the second value of the inbound path preference attribute comprises:
applying the second link speed to an inverse logarithmic function, resulting in an intermediate value; and
adding the intermediate value to the first value, resulting in the second value.

18. A networking configuration method, comprising:
receiving, by a first network device, from a second network device, an advertisement of a subnet, the advertisement comprising a first value of an inbound path preference attribute of a routing protocol;
determining, by the first network device, a link speed of a link between the first network device and a third network device;
determining, by the first network device, a second value of the inbound path preference attribute based on the determined link speed and the first value of the inbound path preference attribute;
advertising, by the first network device, the subnet to the third network device in association with the second value of the inbound path preference attribute;
determining, by the first network device, a value of an outbound path preference attribute of the routing protocol based on the first value of the inbound path preference attribute;
adding, by the first network device, a routing entry corresponding to the second network device and the subnet and comprising the value of the outbound path preference attribute, to a routing table of the first network device; and
routing, by the first network device, a data packet from the third network device to the second network device in accordance with the routing entry.

19. The networking configuration method of claim 18, wherein the routing protocol is Border Gateway Protocol (BGP), the inbound path preference attribute is a multi-exit discriminator (MED) attribute of BGP, and the outbound path preference attribute is a local preference (LP) attribute of BGP.

20. The networking configuration method of claim 18, wherein determining, by the first network device, the value of the outbound path preference attribute of the routing protocol based on the first value of the inbound path preference attribute, comprises:
applying the first value of the inbound path preference attribute to a conversion function, wherein lower values of the inbound path preference attribute applied to the conversion function result in higher values of the outbound path preference attribute resulting from the conversion function.
